(19) United States
(12) Patent Application Publication
(10) Pub. No.: US 2026/0225651 A1
(43) Pub. Date: Aug. 6, 2026

(54) INDEPENDENT REAR WHEEL STEERING CONTROL APPARATUS AND METHOD THEREFOR

(71) Applicant: HYUNDAI MOBIS CO., LTD., Seoul (KR)

(72) Inventor: Kyoung Wook MIN, Yongin-si (KR)

(73) Assignee: HYUNDAI MOBIS CO., LTD., Seoul (KR)

(21) Appl. No.: 19/323,114

(22) Filed: Sep. 9, 2025

(30) Foreign Application Priority Data
Feb. 5, 2025 (KR) 10-2025-0014749

(51) Int. Cl. B62D 7/15

(52) U.S. Cl. CPC B62D 7/159

(57) ABSTRACT

Disclosed is an independent rear wheel steering control apparatus. The independent rear wheel steering control apparatus includes a sensor module that collects vehicle status data, and a processor that determines whether the vehicle enters rapid acceleration based on the vehicle status data collected through the sensor module, and the processor performs toe-in control through a rear wheel steering device when it is determined that the vehicle enters the rapid acceleration

### CROSS-REFERENCE TO RELATED APPLICATIONS

This application claims the benefit under 35 U.S.C. §119(a) of priority to Korean Patent Application No. 10-2025-0014749 filed on February 5, 2025, in the Korean Intellectual Property Office, the entire disclosure of which is incorporated herein by reference for all purposes.

### TECHNICAL FIELD

The present disclosure relates to an independent rear wheel steering control apparatus that can improve a driver's straight-line stability during rapid acceleration of a vehicle and a method therefor.

### BACKGROUND

Typically, the rear wheel steering (RWS) of a vehicle is equipped with a hydraulic device, a motor, and a reducer to steer the rear wheels of the vehicle according to driving conditions of the vehicle.

The rear wheel steering system (RWS) is generally operated for the purpose of reducing a turning radius when the vehicle is driven at low speed and improving driving stability when the vehicle is driven at high speed. That is, when the vehicle is driven at low speed, a rear wheel steering angle is controlled in an opposite direction to a front wheel steering angle, and when the vehicle is driven at high speed, the rear wheel steering angle is controlled in the same direction as the front wheel steering angle.

The current rear-wheel steering (RWS) systems offer the following advantages through reverse or in-phase control when stopping and driving forward.

For example, the turning radius can be reduced through RWS reverse control in stationary or low-speed situation, and vehicle stability can be secured through RWS in-phase control in medium/high-speed situations. In addition, it is known that the RWS control method under rapid acceleration conditions is not available in mass-produced vehicles (e.g., when the steering angle is 0 ° (deg), RWS controls full speed 0 ° (deg)).

However, when a vehicle accelerates rapidly, the center of gravity of the vehicle shifts rearward, causing a phenomenon called rear squat, which may cause the following problems.

For example, there is a problem in which steering stability is reduced as steering response is reduced due to weakening of the steering front wheel grip as the center of gravity of a vehicle shifts. In addition, in the case of a front-wheel-drive vehicle, the front wheels are responsible not only for steering but also for driving force, which increases the likelihood of slippage. For example, on low-friction surfaces such as wet roads or in cases of excessive tire wear, the grip becomes even more insufficient, further degrading vehicle stability.

In addition, when rear squat occurs, the center of gravity shifts toward the rear axle, altering the suspension geometry. In such cases, the rear wheels tend to shift toward a toe-out state, which degrades the straight-line driving stability of the vehicle.

Accordingly, there is a need for an independent rear-wheel steering control apparatus and method that can improve straight-line stability during rapid acceleration of the vehicle.

The background technology of the present disclosure is disclosed in Korean Patent Publication No. 10-2013-0053699 (published on May 24, 2013).

### SUMMARY

Various embodiments are directed to an independent rear wheel steering control apparatus that can improve a driver's straight-line driving stability during rapid acceleration of a vehicle and a method therefor.

An independent rear wheel steering control apparatus according to an aspect of the present disclosure may include a sensor module that collects vehicle status data, and a processor that determines whether the vehicle enters a rapid acceleration state based on the vehicle status data collected through the sensor module, and the processor may perform toe-in control through a rear wheel steering device when it is determined that the vehicle enters the rapid acceleration state.

The processor may collect vehicle speed, a steering angle, accelerator pedal opening rate, and final acceleration as the vehicle status data through the sensor module, or communicate with an electronic control unit (EUC) to receive the vehicle status data.

The processor may determine whether the vehicle enters the rapid acceleration state by comparing the vehicle status data with a preset rapid acceleration entry determination condition, and determine that the vehicle is in a rapid acceleration entry state when an accelerator pedal opening rate (%) is greater than a specified first opening rate reference and final acceleration is greater than a specified first final acceleration reference.

The processor may determine whether to release rapid acceleration state of the vehicle by comparing the vehicle status data with a preset rapid acceleration release determination condition, and when an accelerator pedal opening rate (%) is less than a specified second opening rate reference and final acceleration is less than a specified second final acceleration reference, the processor may determine that the vehicle is in a rapid acceleration release state.

The processor may start the toe-in control when the vehicle is in a rapid acceleration entry state and ends the toe-in control when the vehicle is in a rapid acceleration release state, and perform ramp-up/down for a specified time to prevent a sense of heterogeneity at the start and end of the toe-in control.

An independent rear wheel steering control method according to an aspect of the present disclosure may include collecting, by a processor, vehicle status data through a sensor module, determining, by the processor, whether a vehicle enters a rapid acceleration state based on the vehicle status data collected through the sensor module, and performing, by the processor, toe-in control through a rear wheel steering system in determining the rapid acceleration entry of the vehicle.

In collecting the vehicle status data through the sensor module, the processor may collect vehicle speed, a steering angle, an accelerator pedal opening rate, and final acceleration as the vehicle status data through the sensor module, or communicates with an electronic control unit (EUC) to receive the vehicle status data.

In determining whether the vehicle enters the rapid acceleration state, the processor determines whether the vehicle enters the rapid acceleration state by comparing the vehicle status data with a preset rapid acceleration entry determination condition, and determine that the vehicle is in a rapid acceleration entry state when an accelerator pedal opening rate (%) is greater than a specified first opening rate reference and final acceleration is greater than a specified first final acceleration reference.

In determining whether the vehicle enters the rapid acceleration state, the processor compares the vehicle status data with a preset rapid release determination condition to determine whether to release the rapid acceleration state of the vehicle, and when the accelerator pedal opening rate (%) is less than a specified second opening rate reference and final acceleration is less than a specified second final acceleration reference, the processor may determine that the vehicle is in a rapid acceleration release state.

In performing the toe-in control through the rear wheel steering device, the processor may start the toe-in control when the vehicle is in the rapid acceleration entry state and ends the toe-in control when the vehicle is in a rapid acceleration release state, and perform ramp-up/down for a specified time to prevent a sense of heterogeneity at the start and end of the toe-in control.

According to the present disclosure, the straight-line driving stability of a driver can be improved when the vehicle rapidly accelerates.

The present disclosure enhances straight-line driving stability by adjusting the rear wheels to a toe-in state during rapid acceleration of the vehicle. This adjustment strengthens the vehicle's tendency to maintain a straight path, thereby reducing lateral swaying during driving and making it easier for the driver to keep the vehicle moving straight. Additionally, the toe-in control increases the contact area between the tires and the road surface, thereby maximizing the ground contact area and improving tire grip. As a result, the vehicle maintains better adherence to the road, contributing to more stable driving.

### BRIEF DESCRIPTION OF THE DRAWINGS

FIG. 1 schematically illustrates an independent rear steering control apparatus according to an embodiment of the present disclosure.

FIG. 2 is a flowchart illustrating an independent rear wheel steering control method according to an embodiment of the present disclosure.

FIG. 3 is an exemplary diagram illustrating straight-line driving stability before and after performing rear wheel toe-in control during rapid acceleration of the vehicle in FIG. 2.

### DETAILED DESCRIPTION

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Hereinafter, with reference to the accompanying drawings, embodiments of the present disclosure will be described in detail so that a person skilled in the art can readily carry out the present disclosure. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. In addition, embodiments that include other components in addition to the components described in the various embodiments are also included in the scope of the present disclosure.

Hereinafter, with reference to the accompanying drawings, embodiments of the present disclosure will be described in detail so that a person skilled in the art can readily carry out the present disclosure. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, when a component is referred to as being “linked,” “coupled,” or “connected” to another component, it is understood that not only a direct connection relationship but also an indirect connection relationship through an intermediate component may also be included. In addition, when a component is referred to as “comprising” or “having” another component, it may mean further inclusion of another component not the exclusion thereof, unless explicitly described to the contrary.

In the present disclosure, the terms first, second, etc. are used only for the purpose of distinguishing one component from another, and do not limit the order or importance of components, etc., unless specifically stated otherwise. Thus, within the scope of this disclosure, a first component in one exemplary embodiment may be referred to as a second component in another embodiment, and similarly a second component in one exemplary embodiment may be referred to as a first component.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. In addition, exemplary embodiments that include other components in addition to the components described in the various embodiments are also included in the scope of the present disclosure.

Hereinafter, an independent rear steering control apparatus and a method therefor according to an embodiment of the present disclosure will be described in detail below with reference to the accompanying drawings through various exemplary embodiments. It should be considered that the thickness of each line or the size of each component in the drawings may be exaggeratedly illustrated for clarity and convenience of description.

In addition, terms to be described below have been defined by taking into consideration their functions in the present disclosure, and may be different depending on a user or operator’s intention or practice. Accordingly, such terms should be interpreted based on the overall contents of this specification.

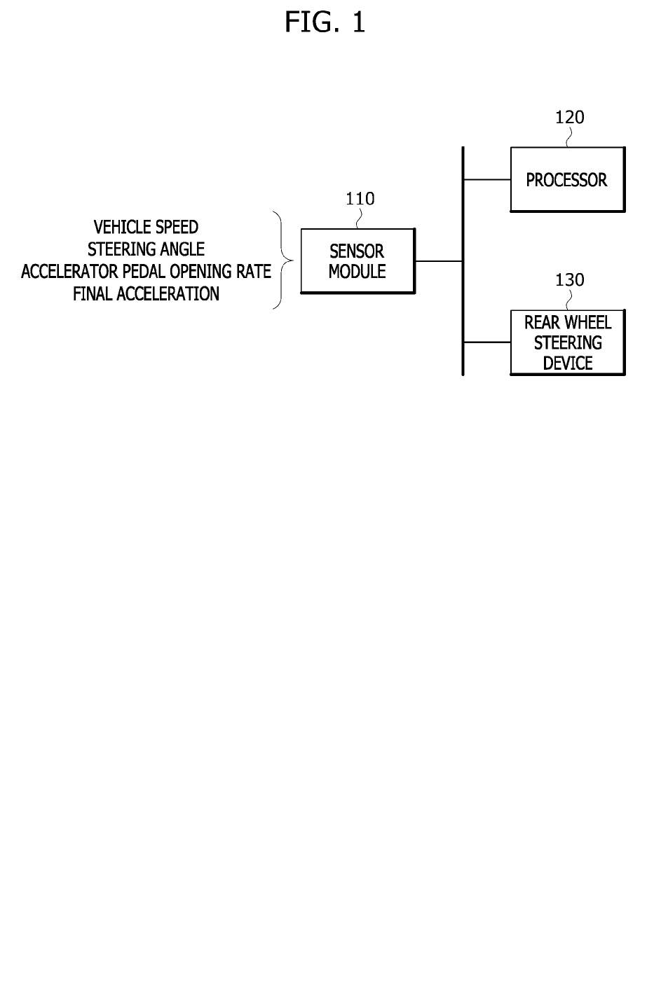

FIG. 1 schematically illustrates an independent rear steering control apparatus according to an embodiment of the present disclosure.

Referring to FIG. 1, the independent rear steering control apparatus according to the present embodiment includes a sensor module 110, a processor 120, and a rear wheel steering device 130.

The sensor module 110 communicates with at least one sensor or electronic control unit (EUC) (not shown) installed in the vehicle and detects vehicle speed, a steering angle, an accelerator pedal opening rate, and final acceleration.

The processor 120 also receives additional vehicle status information (that is, vehicle status data) in addition to the information detected through the sensor module 110 by communicating with an EUC (not shown).

The processor 120 determines braking and turning of the vehicle using the vehicle status information directly detected using at least one sensor or vehicle status information received from the EUC (not shown), and determines whether the vehicle accelerates rapidly and calculates a toe-in control amount during rapid acceleration of the vehicle.

The processor 120 controls the rear wheel steering device 130 according to the calculated toe-in control amount or the rear wheel steering angle.

In general, the conventional RWS could not arbitrarily change the toe angle of the rear wheel tire during rapid acceleration.

However, the independent rear wheel steering control apparatus according to the present embodiment is configured to simultaneously control the toe angles of the rear tires in a toe-in direction during rapid acceleration, thereby enhancing the straight-line driving stability of the vehicle.

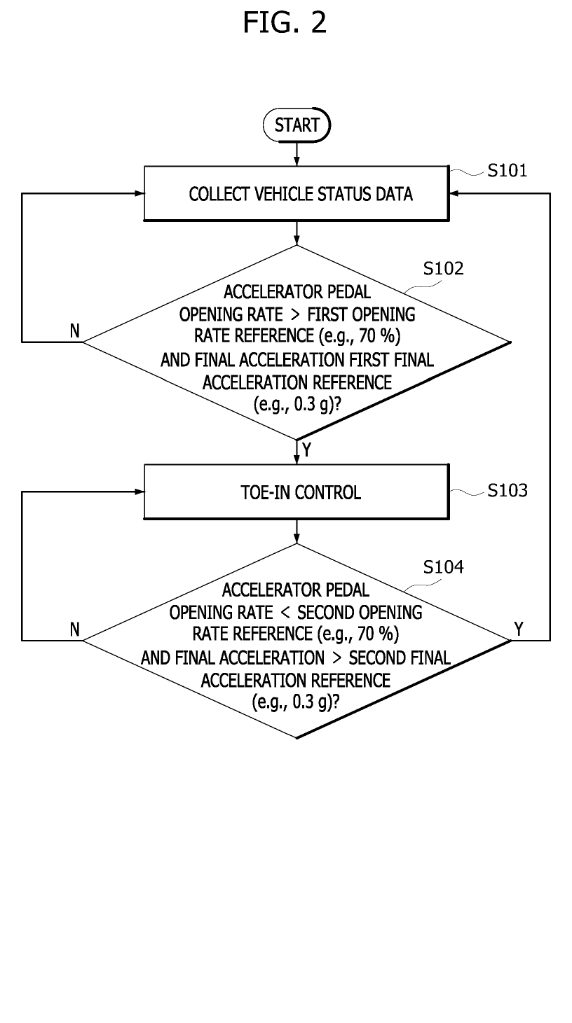

Hereinafter, the operation of the processor 120 is described in more detail with reference to FIG. 2.

FIG. 2 is a flowchart illustrating an independent rear wheel steering control method according to an embodiment of the present disclosure.

Referring to FIG. 2 along with FIG. 1, the processor 120 collects vehicle status data through the sensor module 110 (S101).

For example, the vehicle status data (that is, vehicle status information) may include vehicle speed, a steering angle, an accelerator pedal opening rate, and final acceleration.

The processor 120 may directly detect (or collect) the vehicle status data using at least one sensor, or receive the vehicle status data from an EUC (not shown).

The processor 120 compares the detected (or collected) vehicle status data with preset rapid acceleration entry determination conditions to determine whether the vehicle enters a rapid acceleration state(S102).

For example, the processor 120 may determine whether the vehicle enters the rapid acceleration state by comparing whether the accelerator pedal opening rate (%) is greater than a specified first opening rate reference (for example, 70%) and whether the final acceleration is greater than a specified first final acceleration reference (for example, 0.5 g) (m/s2).

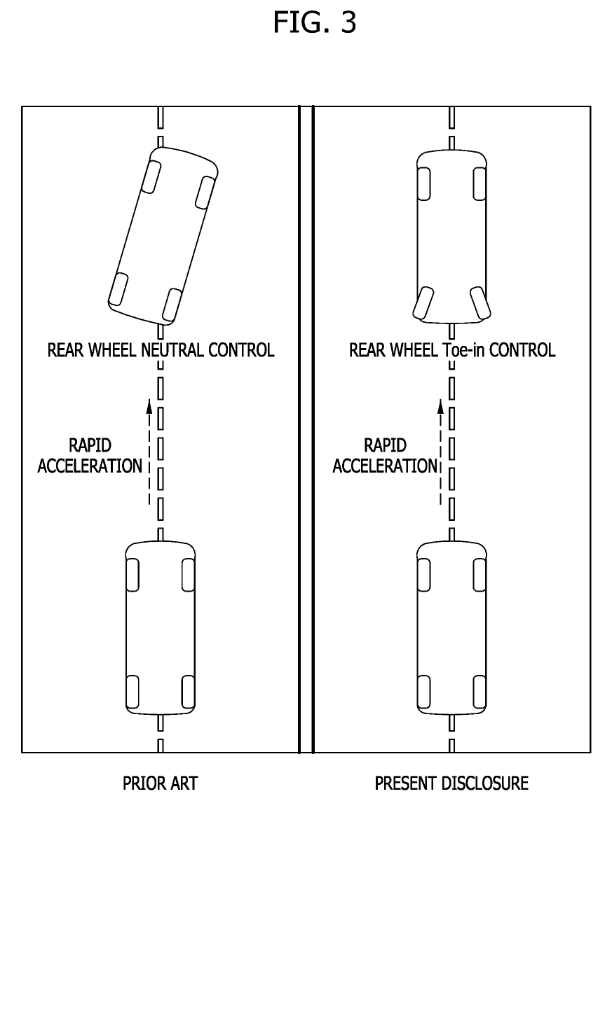

When the result of comparing the detected (or collected) vehicle status data with the preset rapid acceleration determination conditions is satisfied (Y in S102), the processor 120 determines that the vehicle is in the rapid acceleration entry state and performs toe-in control (S103) (refer to FIG. 3).

For example, when it is determined that the vehicle is in the rapid acceleration entry state, the toe-in control amount is determined, which may be set as a tuning parameter.

While toe-in control is performed according to the rapid acceleration entry of the vehicle, the processor 120 continuously detects (or collects) the vehicle status data.

After performing toe-in control in the rapid acceleration entry state of the vehicle, the processor 120 determines whether to release the rapid acceleration state of the vehicle by comparing the detected (or collected) vehicle status data with a preset rapid acceleration release determination condition (S104).

For example, the processor 120 may determine whether to release the rapid acceleration state of the vehicle by comparing whether the accelerator pedal opening rate (%) is smaller than the specified second opening rate reference (for example, 50%) and the final acceleration is smaller than the specified second final acceleration reference (for example, 0.3g) (m/s2).

When the result of comparing the detected (or collected) vehicle status data with the preset rapid acceleration release determination condition is satisfied (Y in S104), the processor 120 determines that the rapid acceleration of the vehicle is released and ends the toe-in control.

When the result of comparing the detected (or collected) vehicle status data with the preset rapid acceleration release determination condition is not satisfied (N in S104), the processor 120 continues to perform the toe-in control.

After the toe-in control is ended according to the rapid acceleration release of the vehicle, the processor 120 continuously detects (or collects) the vehicle status data while the vehicle is driving (S101).

Meanwhile, although not specifically illustrated in the drawing, in order to prevent the sense of heterogeneity at the start and end of the toe-in control, the processor 120 performs ramp up/down for a specified time (for example, one second (s)).

In addition, the rapid acceleration entry/release determination conditions for starting/ending the toe-in control of the rear wheel steering device 130 may be set differently for each specification of the vehicle.

FIG. 3 is an exemplary diagram illustrating straight-line driving stability before and after performing rear wheel toe-in control during rapid acceleration of the vehicle in FIG. 2.

Referring to FIG. 3 along with FIG. 1, the processor 120 can improve straight-line driving stability by performing toe-in control of the rear wheel steering device 130 when determining the start of rapid acceleration of the vehicle.

Conventionally, during rapid acceleration of a vehicle, the rear wheels remain in a neutral state and simply follow the driving axle without active steering, which results in reduced stability of the rear wheels under such conditions. This increases the likelihood of vehicle shaking or lateral slippage, and may make it difficult to control the vehicle during high-speed driving.

In contrast, according to the embodiment of the present disclosure, the rear wheels are controlled to a toe-in state (that is, directed inward toward the vehicle body) during the rapid acceleration of the vehicle, thereby enhancing the stability of the rear wheels. As a result, rear-wheel traction and overall driving stability are significantly improved, vehicle shaking is prevented, and straight-line driving performance is maintained.

As described above, the present embodiment improves the straight-line driving stability of the vehicle by adjusting the rear wheels to a toe-in state (that is, a slight inward angle of the wheels) during rapid acceleration of the vehicle. This causes the vehicle to have a stronger tendency to maintain a straight path, thereby reducing shaking during driving and making it easier for the driver to keep the vehicle aligned.

This enhances tire grip by maximizing the contact area between the tires and the road surface, as the toe-in control causes the tires to adhere more broadly to the ground. As a result, the frictional force between the tires and the road increases, allowing the vehicle to travel more stably while maintaining firm contact with the road.

In particular, in the case of a rear-wheel-drive vehicle, the driving force generated by the rear wheels can be more effectively transmitted to the road surface as the rear wheels maintain firm contact with the ground, allowing the vehicle to accelerate more powerfully while maintaining stability.

As such, the present embodiment significantly improves straight-line driving performance during rapid acceleration by the driver, preventing the vehicle from shaking or becoming difficult to control. In addition, by maximizing the adhesion between the tires and the road surface, the tires remain firmly in contact with the road, enabling safer driving and contributing to reduced tire wear.

Although exemplary embodiments of the disclosure have been disclosed for illustrative purposes, those skilled in the art will appreciate that various modifications, additions and substitutions are possible, without departing from the scope and spirit of the disclosure as defined in the accompanying claims. Thus, the true technical scope of the disclosure should be defined by the following claims.

What is claimed is:

1. An independent rear wheel steering control apparatus comprising:
a sensor module configured to collect vehicle status data;
a processor; and
a memory, coupled to the processor and configured to store executable instructions, wherein the instructions, when executed by the processor, cause the processor to:
determine whether the vehicle enters a rapid acceleration state based on the vehicle status data collected through the sensor module; and
perform toe-in control through a rear wheel steering apparatus when it is determined that the vehicle enters the rapid acceleration state.

2. The independent rear wheel steering control apparatus of claim 1, wherein the instructions cause the processor to collect vehicle speed, a steering angle, accelerator pedal opening rate, and final acceleration as the vehicle status data through the sensor module, or to communicate with an electronic control unit (EUC) to receive the vehicle status data.

3. The independent rear wheel steering control apparatus of claim 1,
wherein the instructions cause the processor to determine whether the vehicle enters the rapid acceleration state by comparing the vehicle status data with a preset rapid acceleration entry determination condition, and
wherein the instructions further cause the processor to determine that the vehicle is in a rapid acceleration entry state when an accelerator pedal opening rate (%) is greater than a specified first opening rate reference and final acceleration is greater than a specified first final acceleration reference.

4. The independent rear wheel steering control apparatus of claim 1,
wherein the instructions cause the processor to determine whether to release rapid acceleration state of the vehicle by comparing the vehicle status data with a preset rapid acceleration release determination condition, and
wherein when an accelerator pedal opening rate (%) is less than a specified second opening rate reference and a final acceleration is less than a specified second final acceleration reference, the instructions cause the processor to determine that the vehicle is in a rapid acceleration release state.

5. The independent rear wheel steering control apparatus of claim 1,
wherein the instructions cause the processor to start the toe-in control when the vehicle is in a rapid acceleration entry state and ends the toe-in control when the vehicle is in a rapid acceleration release state, and
wherein the instructions cause the processor to perform ramp-up/down for a specified time to prevent a sense of heterogeneity at the start and end of the toe-in control.

6. An independent rear wheel steering control method comprising:
collecting, by a processor, vehicle status data through a sensor module;
determining, by the processor, whether a vehicle enters a rapid acceleration state based on the vehicle status data collected through the sensor module; and
performing, by the processor, toe-in control of the rear wheels of the vehicle through a rear wheel steering system upon determining entry of the vehicle into the rapid acceleration state.

7. The independent rear wheel steering control method of claim 6, wherein, for collecting the vehicle status data through the sensor module, the processor collects vehicle speed, a steering angle, an accelerator pedal opening rate, and final acceleration as the vehicle status data through the sensor module, or communicates with an electronic control unit (EUC) to receive the vehicle status data.

8. The independent rear wheel steering control method of claim 6,
whereinfor determining whether the vehicle enters the rapid acceleration state, the method further comprises determining, by the processor, whether the vehicle enters the rapid acceleration state by comparing the vehicle status data with a preset rapid acceleration entry determination condition, and
wherein the method further comprises determining, by the processor, that the vehicle is in a rapid acceleration entry state when an accelerator pedal opening rate (%) is greater than a specified first opening rate reference and final acceleration is greater than a specified first final acceleration reference.

9. The independent rear wheel steering control method of claim 6,
wherein for determining whether the vehicle enters the rapid acceleration state, the method further comprises comparing, by the processor, the vehicle status data with a preset rapid release determination condition to determine whether to release the rapid acceleration of the vehicle, and
wherein when an accelerator pedal opening rate (%) is less than a specified second opening rate reference and final acceleration is less than a specified second final acceleration reference, the method further comprises determining, by the processor, that the vehicle is in a rapid acceleration release state.

10. The independent rear wheel steering control method of claim 6,
wherein in performing the toe-in control through the rear wheel steering system, the method further comprises starting, by the processor,the toe-in control when the vehicle is in a rapid acceleration entry state and ends the toe-in control when the vehicle is in a rapid acceleration release state, and
wherein the method further comprises performing, by the processor, ramp-up/down for a specified time to prevent a sense of heterogeneity at the start and end of the toe-in control.
